(19) United States
(12) Patent Application Publication
(10) Pub. No.: US 2010/0306563 A1
(43) Pub. Date: Dec. 2, 2010

(54) COMPUTER SYSTEM FOR SAVING POWER CONSUMPTION OF A STAND-BY/POWER-OFF STATE AND METHOD THEREOF

(76) Inventors: Tseng-Wen Chen, Hsinchu (TW); Tsung-Hsueh Li, Hsinchu (TW); Chun-Kan Huang, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/616,134

(22) Filed: Nov. 10, 2009

(30) Foreign Application Priority Data
May 26, 2009 (TW) 098117510

(51) Int. Cl. G06F 1/32

(52) U.S. Cl. 713/323

(57) ABSTRACT

A computer system consists of a plurality of electronic elements and a switch control circuit. The switch control circuit controls the computer system to enter a stand-by/power off state from a normal state when the computer system receives a stand-by/power off command under the normal state, and stops outputting a stand-by power having at least one stand-by voltage level to at least one part of electronic elements among the plurality of electronic elements. At this time, the computer system has entered a simulated mechanical off state from the stand-by/power off state. A number of electronic elements supplied by the stand-by power when the computer system lies under the simulated mechanical off state is smaller than a number of electronic elements supplied by the stand-by power when the computer system lies under the stand-by/power off state.

### BACKGROUND OF THE INVENTION

1. Field of the Invention

The present invention relates to a computer system capable of saving power consumption and a related method, and more particularly, to a computer system capable of saving power consumption of a stand-by/power off state (e.g. power states S3, S4, and S5) and a related method.

2. Description of the Prior Art

Recently, as for electronic products are concerned, demands for energy conservation have been increasing day by day. According to the standard of Eco-Design Requirements for Energy Using Products (EuP) announced by the European Union in 2005 A.D., the designs of future computer products must be satisfied with this standard to be able to import to the European Union. During the first stage, the power consumption of the computer system under a stand-by/power off state should be smaller than 1 watt. Behind 2013 A.D., the power consumption of the computer system under the stand-by/power off state should be smaller than 0.5 watt. In order to conform to this new standard, a power-saving mechanism for the computer system is provided in the present invention, such that the computer system is able to achieve the requirements of energy conservation under the stand-by/power off state.

Please refer to FIG. 1. FIG. 1 is a diagram showing power states of an ACPI power management system according to the prior art. In today's ACPI power management system, seven power states for the computer system are defined, namely: a normal state “G0” (can also be called as S0), a sleeping state “G1” (can further be subdivided into S1, S2, S3, and S4), a soft off state “G2” (can also be called as S5), and a mechanical off state “G3”. What's more, currently there are three kinds of power supplies used in the motherboard of the computer system, that is: a battery power V_{BAT}, a main power V_{CC}, and a stand-by power V_{SB}. The stand-by power V_{SB} is always power-supplied except for the mechanical off state G3, while the main power V_{CC} is power-supplied only under the power states S0, S1, and S2.

In general, the operating system (OS) and application programs of the computer system are still working under the normal state S0, and all of the battery power V_{BAT}, the main power V_{CC}, and the stand-by power V_{SB} are power-supplied. The supplied situation of the power state S1 is similar to that of the normal state S0, and the difference between them is that the CPU stops executing instructions under the power state S1, but the power supply still needs to provide power to the CPU, the memory, and the other electronic elements at this time. The supplied situation of the power state S2 is similar to that of the power state S1, and the difference between them is that the CPU is not power-supplied under the power state S2, but the power supply still needs to provide power to the memory and the other electronic elements at this time. The power state S3 can be called as a Suspend to RAM (STR) state, wherein it is known as the “stand-by state” in Micro-Soft XP OS or Linux OS while it is known as the “sleeping state” in Micro-Soft Vista OS or Mac OS X. For the time being, only the memory needs to be supplied with power (i.e., the stand-by power V_{SB})/and the power supply has no need to output the main power V_{CC} to the computer system anymore. The power state S4 can also be called as a Suspend to Disk (STD) state, wherein it is known as the “Hibernate state” in Micro-Soft OS while it is known as the “safe sleeping state” in Mac OS X. For the time being, the power supply has no need to output the stand-by power V_{SB} to the memory. The power state S4 and the other power states S1, S2, S3 differ in several ways, be noted that the power state S4 is more similar to the soft off state “G2” and the mechanical off state “G3”.

As for ACPI standard is concerned, the stand-by/power off state (i.e., the power states S3, S4, and S5) is the most power-saving condition of the computer system. For this reason, few manufactures will be significant for power-saving designs upon the power states S3, S4, and S5. However, recently there is still unnecessary power waste under the power states S3, S4, and S5 of the computer system; for example, some non-working electronic elements are still supplied with power by the stand-by power V_{SB} at this time. Hence, a power-saving design upon the stand-by/power off state of the computer system is required, so as to conform to the future concept of energy conservation.

### SUMMARY OF THE INVENTION

It is one of the objectives of the claimed invention to provide a computer system for saving power consumption of a stand-by/power off state and a related control method to solve the above-mentioned problems.

According to one embodiment, a computer system for saving power consumption of a stand-by/power off state is provided. The computer system consists of a plurality of electronic elements and a switch control circuit. The switch control circuit is coupled to the plurality of electronic elements. When the computer system receives a stand-by/power off command under the normal state, the switch control circuit is used for controlling the computer system to enter the stand-by/power off state from a normal state, and for stopping outputting a stand-by power having at least one stand-by voltage level to at least one part of electronic elements among the plurality of electronic elements. At this time, the computer system has entered a simulated mechanical off state from the stand-by/power off state. Be noted that a number of electronic elements supplied by the stand-by power when the computer system lies under the simulated mechanical off state is smaller than a number of electronic elements supplied by the stand-by power when the computer system lies under the stand-by/power off state. When the computer system receives a wake-up event under the simulated mechanical off state, the switch control circuit is further used for restoring the output of the stand-by power to the plurality of electronic elements, and for controlling the computer system to return to the stand-by/power off state from the simulated mechanical off state and then return to the normal state from the stand-by/power off state. The stand-by/power off state comprises one of a stand-by state (S3), a sleeping state (S4) and a power off state (S5).

According to another embodiment, a computer system for saving power consumption of a stand-by/power off state is provided. The computer system consists of a power converting circuit, a plurality of electronic elements, and a switch control circuit. The power converting circuit converts an input power into a main power as well as a stand-by power comprising a plurality of stand-by voltage levels. The plurality of electronic elements are coupled to the power converting circuit, wherein power supplies of the plurality of electronic elements are derived from the main power as well as the stand-by power. The switch control circuit is coupled to the power converting circuit. When the computer system receives a stand-by/power off command under the normal state, the switch control circuit used for controlling the computer system to enter the stand-by/power off state from a normal state and for controlling the power converting circuit to stop converting the input power into at least one part of stand-by voltage levels among the plurality of stand-by voltage levels, such that the computer system has entered a simulated mechanical off state from the stand-by/power off state at this time.

According to another embodiment, a method for saving power consumption of a computer system under a stand-by/power off state is provided, wherein the computer system consists of a plurality of electronic elements. The method includes the steps of: when the computer system receives a stand-by/power off command under a normal state, controlling the computer system to enter the stand-by/power off state from the normal state; and stopping outputting a stand-by power having at least one stand-by voltage level to at least one part of electronic elements among the plurality of electronic elements, such that the computer system has entered a simulated mechanical off state from the stand-by/power off state at this time; wherein a number of electronic elements supplied by the stand-by power when the computer system lies under the simulated mechanical off state is smaller than a number of electronic elements supplied by the stand-by power when the computer system lies under the stand-by/power off state.

According to another embodiment, a method for saving power consumption of a computer system under a stand-by/power off state is provided, wherein the computer system consist of a plurality of electronic elements, and power supplies of the plurality of electronic elements are derived from a main power as well as a stand-by power comprising a plurality of stand-by voltage levels. The method includes the steps of: when the computer system receives a stand-by/power off command under the normal state, controlling the computer system to enter the stand-by/power off state from a normal state; and stopping converting an input power into at least one part of stand-by voltage levels among the plurality of stand-by voltage levels, such that the computer system has entered a simulated mechanical off state from the stand-by/power off state at this time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing power states of an ACPI power management system according to the prior art.

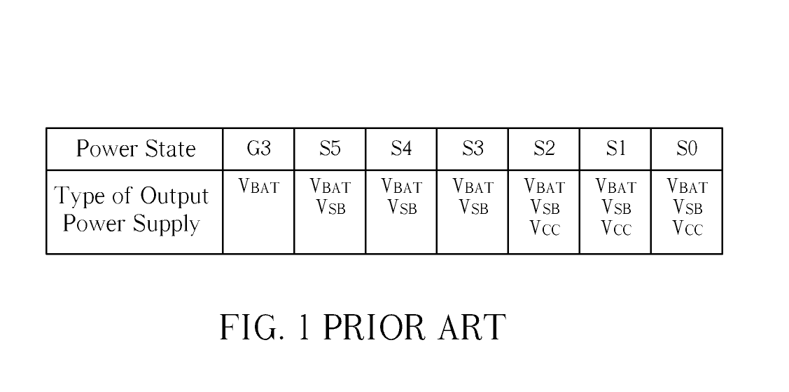

FIG. 2 is a diagram of a computer system for saving power consumption of a stand-by/power off state according to a first embodiment of the present invention.

FIG. 3 is a diagram showing an exemplary embodiment of the switch control circuit shown in FIG. 2.

FIG. 4 is a diagram showing another exemplary embodiment of the switch control circuit shown in FIG. 2.

FIG. 5 is a diagram of a computer system for saving power consumption of a stand-by/power off state according to a second embodiment of the present invention.

FIG. 6 is a diagram showing an exemplary embodiment of the switch control circuit shown in FIG. 5.

FIG. 7 is a diagram showing another exemplary embodiment of the switch control circuit shown in FIG. 5.

FIG. 8A is a flowchart illustrating a method for saving power consumption of a computer system under a stand-by/power off state according to an exemplary embodiment of the present invention.

FIG. 8B is a flowchart illustrating a method for saving power consumption of a computer system under a stand-by/power off state according to another exemplary embodiment of the present invention.

FIG. 9A is a flowchart illustrating a method for saving power consumption of a computer system under a stand-by/power off state according to another exemplary embodiment of the present invention.

FIG. 9B is a flowchart illustrating a method for saving power consumption of a computer system under a stand-by/power off state according to another exemplary embodiment of the present invention.

### DETAILED DESCRIPTION

The following embodiments are focused on that: if the computer system enters the stand-by/power state, the stand-by power V_{SB} provided for one part (or all) of the electronic elements can be stopped and the computer system can enter a simulated mechanical off state; and if the computer system needs to wake up to work (for example, when a wake-up event is received), the computer system can return to the stand-by/power off state form the simulated mechanical off state and then return to the normal state from the stand-by/power off state timely. Therefore, an optimum power-saving performance can be achieved. What's more, in the following embodiments, the normal state includes the power state S0; the stand-by/power off state includes one of the stand-by state S3, the sleeping state S4, and the power off state S5; and the simulated mechanical off state is represented by G3′ or G3″. The simulated mechanical off state G3′/G3″ mentioned herein is similar to the mechanical off state G3 defined in the ACPI power management system, wherein the output power supply provided by the simulated mechanical off state G3′/G3″ only consists of the battery power V_{BAT} as well as a small part of the stand-by power V_{SB} (for example, the stand-by voltage level provided to the memory device and/or the wake-up device). Perfectly, all of the stand-by power V_{SB} can be disabled while only the battery power V_{BAT} is provided under the simulated mechanical off state G3′/G3″, such that the simulated mechanical off state G3′/G3″ can be viewed completely the same as the mechanical off state G3 in this condition.

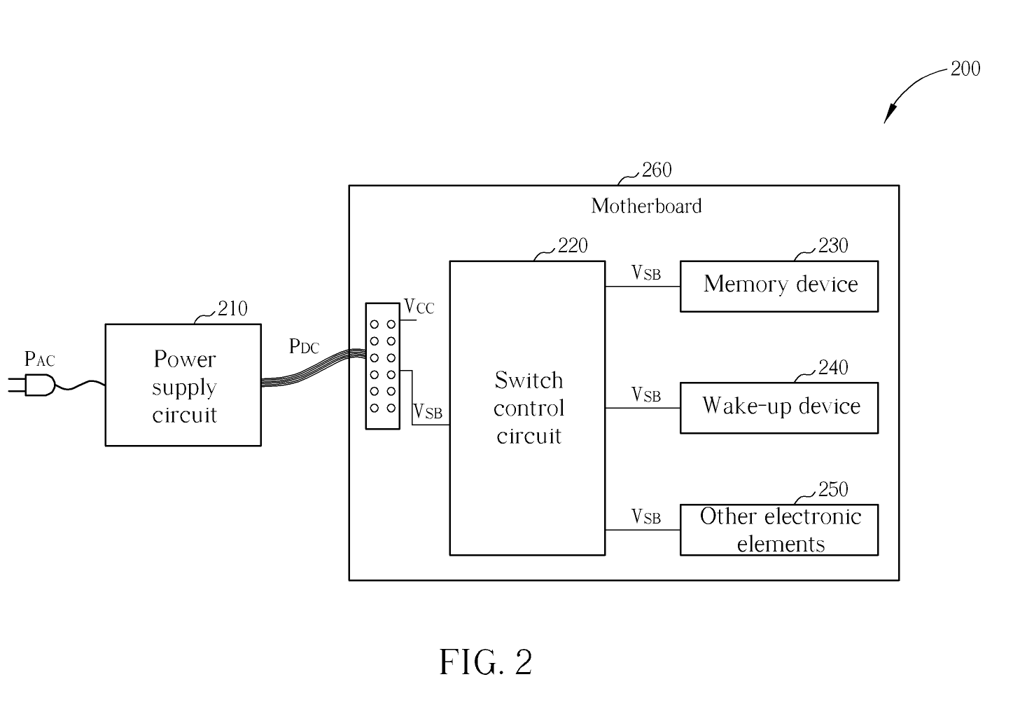

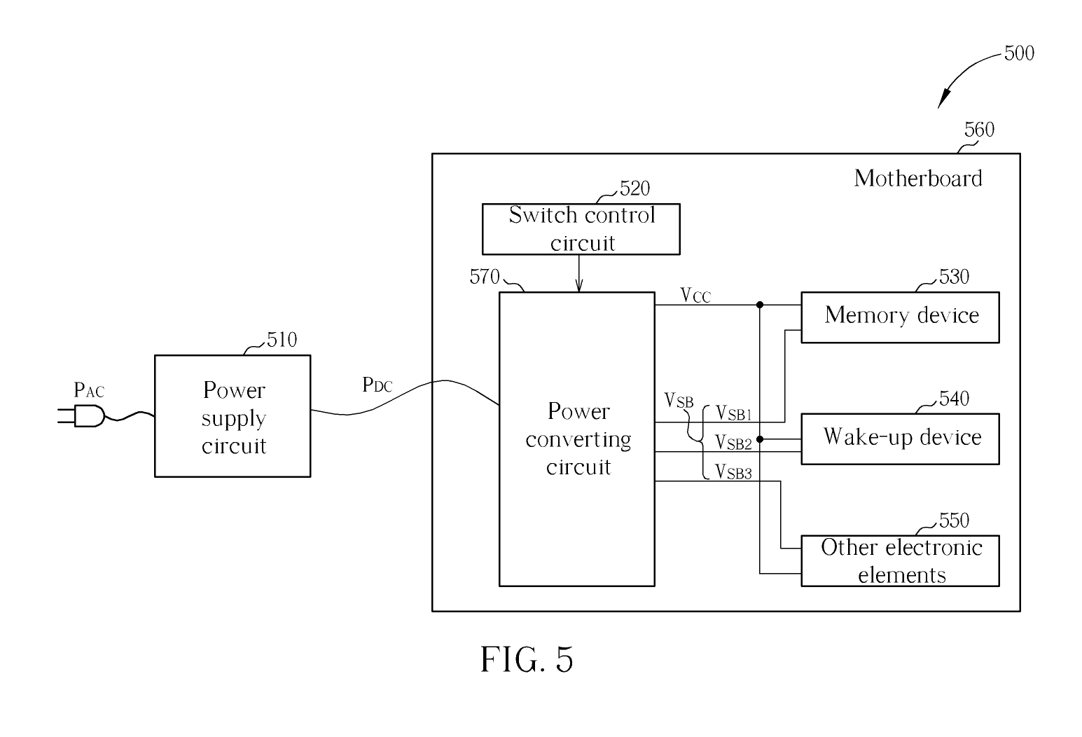

Nowadays the power supply adopted in the computer system can be divided into two types: the first type of power supply is applied to a desktop computer, such as ATX, micro ATX, BTX, . . . and so on, which can directly convert an alternating current (AC) of 110V/220V into a plurality of direct currents (DC) (e.g., 3.3V, 5V, and 5VSB) to be outputted to the motherboard of the computer system; and the second type of power supply is applied to a notebook computer, which can convert the alternating current (AC) of 110V/220V into a single direct current (e.g., 19V or 24V), and then the direct current of 19V/24V is designed into various different voltage levels (e.g., 3.3V, 5V, 5VSB, 3VSB, . . . and so on) via a power converting device. In the embodiments below, the first embodiment disclosed in FIG. 2 is in the light of the desktop computer, and the second embodiment disclosed in FIG. 5 is in the light of the notebook computer or the laptop computer.

Please refer to FIG. 2. FIG. 2 is a diagram of a computer system 200 for saving power consumption of a stand-by/power off state according to a first embodiment of the present invention. As shown in FIG. 2, the computer system 200 includes, but is not limited to, a power supply circuit 210, a switch control circuit 220, and a plurality of electronic elements 230˜250. In this embodiment, a memory device 230, a wake-up device 240 (for example, a device equipped with a wake-up function, such as a network card, a keyboard, or an infrared remote controller), and other electronic elements 250 are taken as an example for illustration, but the present invention is not limited to this only. The power supply circuit 210 provides a second input power P_{DC} according to a first input power P_{AC}, wherein the first input power P_{AC} can be an alternating current (AC) of 110V/220V provided from a socket, and the second input power P_{DC} can consist of at least a main power V_{CC} and a stand-by power V_{SB}. In addition, the switch control circuit 220, the memory device 230, the wake-up device 240, and the other electronic elements 250 are all disposed on a motherboard 260. The switch control circuit 220 is coupled between the power supply circuit 210 and the memory device 230, the wake-up device 240, as well as the other electronic elements 250. When the computer system 200 receives a stand-by/power off command under a normal state (e.g. the power state S0), the switch control circuit 220 controls the computer system 200 to enter a stand-by/power off state (e.g. the power state S3, S4, or S5) from the normal state S0 and stops outputting the stand-by power V_{SB} to at least one part of electronic elements among the plurality of electronic elements 230 ˜250, such that the computer system 200 enters a simulated mechanical off state (represented by G3′ or G3″) from the stand-by/power off state. When the computer system 200 receives a wake-up event under the simulated mechanical off state, the switch control circuit 220 restores the output of the stand-by power V_{SB} to the plurality of electronic elements 230˜250, and controls the computer system 200 to return to the stand-by/power off state from the simulated mechanical off state and then return to the normal state from the stand-by/power off state. That is to say, G3′→S3→S0 or G3″→S4/S5→S0.

Please note that the abovementioned stand-by power V_{SB} can include at least one stand-by voltage level (such as 1.8V, 3.3V, and 5V) for providing different voltage levels to different electronic elements, but this in no way should be considered as a limitation of the present invention. Moreover, a number of electronic elements supplied with power by the stand-by power V_{SB} when the computer system 200 lies under the simulated mechanical off state (e.g., the power state G3′/G3″) is smaller than a number of electronic elements supplied with power by the stand-by power V_{SB} when the computer system 200 lies under the stand-by/power off state (e.g., the power state S3, S4, or S5). For example, when the computer system 200 lies under the power state S3, the electronic elements supplied by the stand-by power V_{SB} includes the memory device 230, the wake-up device 240, and the other electronic elements 250. Assume that a number of the other electronic elements 250 is equal to N, and thus a total number of the electronic elements supplied by the stand-by power V_{SB} is equal to (N+2) under the power state S3. On the other hand, when the computer system 200 lies under the simulated mechanical off state G3′/G3″, the electronic elements supplied by the stand-by power V_{SB} only includes the memory device 230 and the wake-up device 240. Namely, the total number of electronic elements supplied by the stand-by power V_{SB} is equal to 2 under the simulated mechanical off state G3′/G3″. For this reason, if the computer system 200 is controlled to enter the stand-by/power off state from the normal state and then enter the simulated mechanical off state from the stand-by/power off state, the power consumption of the computer system 200 under the stand-by/power off state can be substantially reduced.

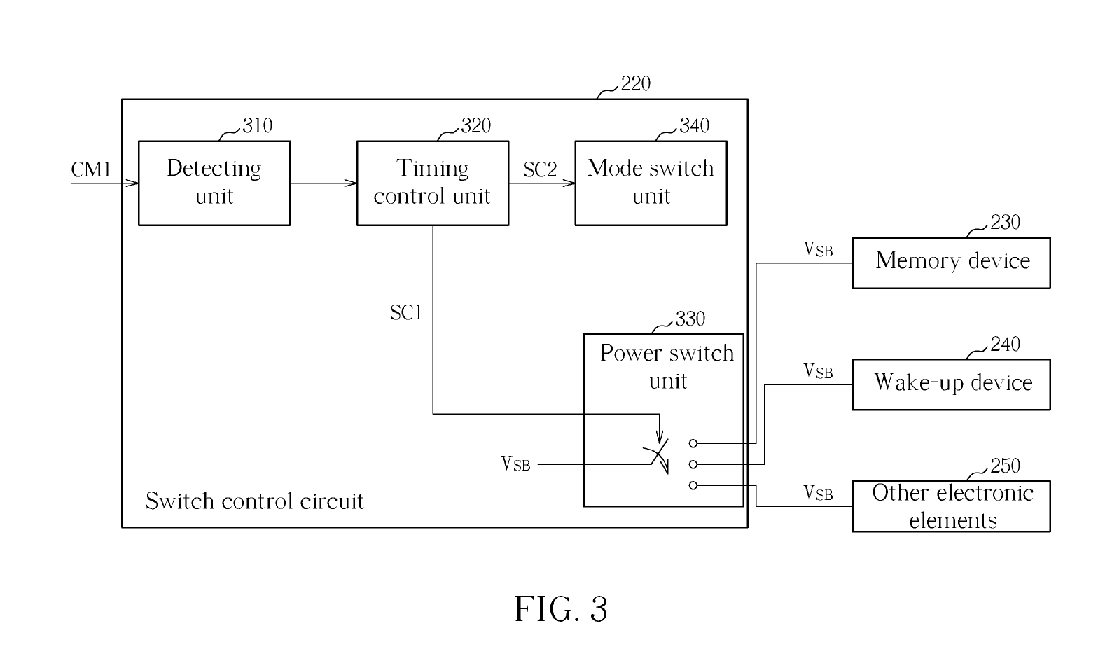

Please refer to FIG. 3. FIG. 3 is a diagram showing an exemplary embodiment of the switch control circuit 220 shown in FIG. 2. In this embodiment, the switch control circuit 220 is applied to a condition that the computer system 200 lies under the normal state S0. As shown in FIG. 3, the switch control circuit 220 includes, but is not limited to, a detecting unit 310, a timing control unit 320, a power switch unit 330, and a mode switch unit 340. When the computer system 200 lies under the normal state S0, the detecting unit 310 detects whether a stand-by/power off command CM1 is received. The timing control unit 320 is coupled to the detecting unit 310. When the detecting unit 310 detects that the stand-by/power off command CM1 is received, the timing control unit 320 generates a mode switch control signal SC2 to the mode switch unit 340. When the mode switch control signal SC2 is received by the mode switch unit 340, the mode switch unit 340 controls the computer system 200 to enter the stand-by/power off state (e.g., the power state S3, S4, or S5) from the normal state S0. At this time, the timing control unit 320 further generates a power switch control signal SC1. The power switch unit 330 is coupled to the timing control unit 320. When the power switch control signal SC1 is received by the power switch unit 330, the power switch unit 330 stops outputting the stand-by power V_{SB} to at least one part of electronic elements among the plurality of electronic elements (including the memory device 230, the wake-up device 240, as well as the other electronic elements 250). After the power switch unit 330 stops outputting the stand-by power V_{SB} to at least one part of electronic elements among the plurality of electronic elements 230˜250, the computer system 200 enters to the simulated mechanical off state (i.e., G3′/G3″) from the stand-by/power off state (such as the power state S3, S4, or S5).

To make it simply, if the switch control circuit 220 receives the stand-by/power off command CM1 during the computer system 200 lies under the normal state S0, it will firstly transmit the mode switch control signal SC2 for controlling the computer system 200 to enter the stand-by/power off state from the normal state S0 and then transmit the power switch control signal SC1 to stop outputting the stand-by power V_{SB} to one part (or most) of the electronic elements. At this time, the computer system 200 has entered the simulated mechanical off state from the stand-by/power off state. That is, S0→S3→G3′ or S0→S4/S5→G3″. Therefore, the power consumption of the computer system 200 under the stand-by/power off state can be saved.

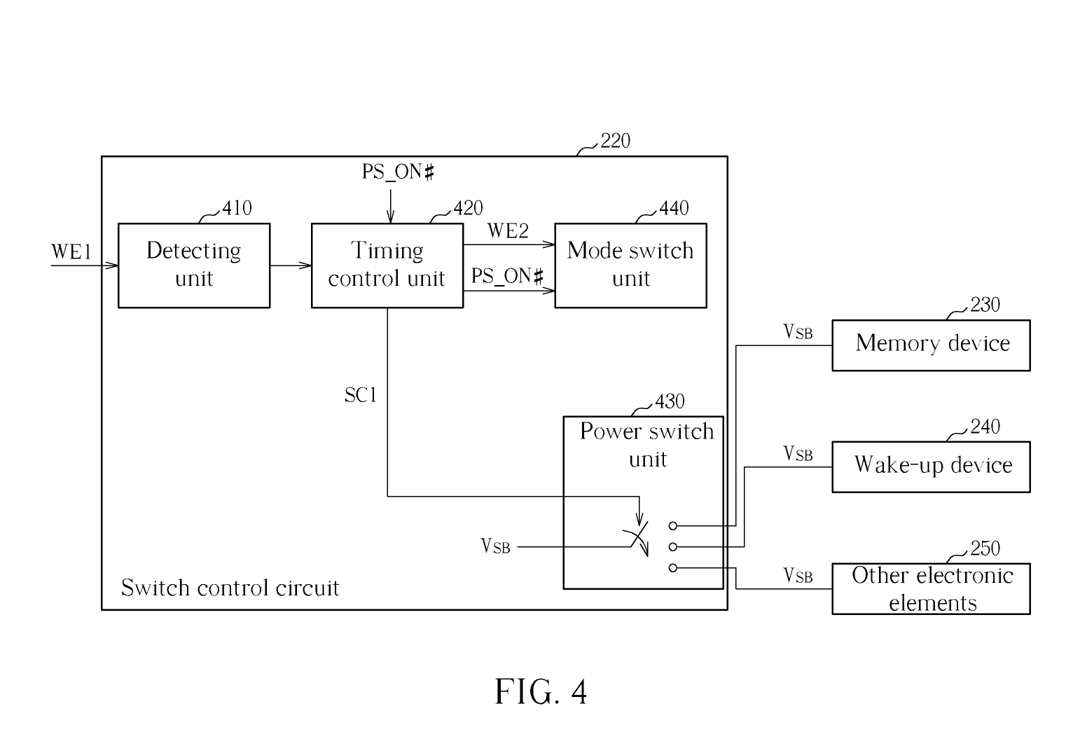

Please refer to FIG. 4. FIG. 4 is a diagram showing another exemplary embodiment of the switch control circuit 220 shown in FIG. 2. In this embodiment, the switch control circuit 220 is applied to a condition that the computer system 200 enters to the simulated mechanical off state G3′/G3″. As shown in FIG. 4, the switch control circuit 220 includes, but is not limited to, a detecting unit 410, a timing control unit 420, a power switch unit 430, and a mode switch unit 440. When the computer system 200 enters to the simulated mechanical off state G3′/G3″, the detecting unit 410 detects whether a wake-up event WE1 is received. The timing control unit 420 is coupled to the detecting unit 410. When the detecting unit 410 detects that the wake-up event WE1 is received, the timing control unit 420 holds a power supply start signal PS_ON# and generates a power switch control signal SC1. The power switch unit 430 is coupled to the timing control unit 420. When the power switch control signal SC1 is received by the power switch unit 430, the power switch unit 430 restores the output of the stand-by power V_{SB} to the plurality of electronic elements (including the memory device 230, the wake-up device 240, and the other electronic elements 250). At this time, after the power switch unit 430 restores the output of the stand-by power V_{SB} to the plurality of electronic elements 230˜250, the timing control unit 420 outputs the power supply start signal PS_ON# together with an output wake-up event WE2 to the mode switch unit 440. When the power supply start signal PS_ON# together with the output wake-up event WE2 are received by the mode switch unit 440, the mode switch unit 440 controls the computer system 200 to return to the stand-by/power off state from the simulated mechanical off state G3′/G3″ and then return to the normal state from the stand-by/power off state.

To make it simply, if the switch control circuit 220 receives the wake-up event WE1 during the computer system 200 enters to the simulated mechanical off state G3′/G3″, it will hold the power supply start signal PS_ON# temporarily and generate the power switch control signal SC1 to restore the output of the stand-by power V_{SB} to the plurality of electronic elements 230˜250. After that, the control circuit 220 outputs the power supply start signal PS_ON# as well as the output wake-up event WE2 to control the computer system 200 to return to the stand-by/power off state from the simulated mechanical off state and then return to the normal state from the stand-by/power off state. That is, G3′ →S3→S0 or G3″→S4/S5→S0. Therefore, even if the computer system 200 enters to the simulated mechanical off state G3′/G3″, it can still wake up to work if needed (for example, when a network wake-up event is received).

Please note that the abovementioned wake-up event WE1 can be generated from internal wake-up devices, such as a network card or a keyboard. However, if these devices are not supplied with power, an external wake-up device (such as a power button) is required so as to trigger such wake-up event WE1. In addition, the above-mentioned output wake-up event WE2 is corresponding to the wake-up event WE1 (e.g. a wake-on-LAN event), and it can be generated by delaying the wake-up event WE1 or by re-sending another wake-up event according to the wake-up event WE1, but this should not be considered as limitations of the present invention. What calls for special attention is that the power supply start signal PS_ON# is a signal received from the motherboard 260 used for controlling whether to enable the power supply. For example, when the power supply start signal PS_ON# is at a low logic level, it indicates that the power supply is enabled; when the power supply start signal PS_ON# is at a high logic level, it indicates that the power supply is disabled.

In the following descriptions, several examples are taken for illustrating how the control circuit 220 switches the stand-by power V_{SB} and how the control circuit 220 switches the power states under different cases.

In a first case, the stand-by/power off state is the stand-by state S3, and the computer system 200 must be equipped with a wake-up function. As a result, when the computer system 200 receives a stand-by/power off command under the normal state S0, the switch control circuit 220 first controls the computer system 200 to enter the stand-by state S3 from the normal state S0, and then stops outputting the stand-by power V_{SB} to the other electronic elements 250 among the plurality of electronic elements 230˜250. At this time, the computer system 200 has entered the simulated mechanical off state G3′ from the stand-by state S3. When the computer system. 200 receives a wake-up event under the simulated mechanical off state G3′, the switch control circuit 220 restores the output of the stand-by power V_{SB} to the other electronic elements 250 among the plurality of electronic elements 230˜250, and controls the computer system 200 to return to the stand-by state S3 from the simulated mechanical off state G3′ and then return to the normal state S0 from the stand-by state S3.

In a second case, the stand-by/power off state is one of the sleeping state S4 and the power off state S5, and the computer system 200 must be equipped with a wake-up function. As a result, when the computer system 200 receives a stand-by/power off command under the normal state S0, the switch control circuit 220 first controls the computer system 200 to enter the power state S4/S5 from the normal state S0, and then stops outputting the stand-by power V_{SB} to the memory 230 and the other electronic elements 250 among the plurality of electronic elements 230˜250. At this time, the computer system 200 has entered the simulated mechanical off state G3″ from the power state S4/S5. When the computer system 200 receives a wake-up event under the simulated mechanical off state G3″, the switch control circuit 220 restores the output of the stand-by power V_{SB} to the memory device 230 and the other electronic elements 250 among the plurality of electronic elements 230˜250, and controls the computer system 200 to return to the power state S4/S5 from the simulated mechanical off state G3″ and then return to the normal state S0 from the power state S4/S5.

In a third case, the stand-by/power off state is the stand-by state S3, and the computer system 200 needs not have a wake-up function. As a result, when the computer system 200 receives a stand-by/power off command under the normal state S0, the switch control circuit 220 first controls the computer system 200 to enter the stand-by state S3 from the normal state S0, and then stops outputting the stand-by power V_{SB} to the wake-up device 240 and the other electronic elements 250 among the plurality of electronic elements 230˜250. At this time, the computer system 200 has entered the simulated mechanical off state G3′ from the stand-by state S3. When the computer system 200 receives a wake-up event under the simulated mechanical off state G3′, the switch control circuit 220 restores the output of the stand-by power V_{SB} to the wake-up device 240 and the other electronic elements 250 among the plurality of electronic elements 230˜250, and controls the computer system 200 to return to the stand-by state S3 from the simulated mechanical off state G3′ and then return to the normal state S0 from the stand-by state S3. What calls for special attention is that, in this third case, the wake-up device 240 inside the computer system 200 is not supplied with power under the simulated mechanical off state G3′. For this reason, the wake-up event needs to be triggered by means of external wake-up devices only, such as a power button.

In a fourth case, the stand-by/power off state is one of the sleeping state S4 and the power off state S5, and the computer system 200 needs not have a wake-up function. As a result, when the computer system 200 receives a stand-by/power off command under the normal state S0, the switch control circuit 220 first controls the computer system 200 to enter the power state S4/S5 from the normal state S0, and then stops outputting the stand-by power V_{SB} to the memory 230, the wake-up device 240, and the other electronic elements 250 among the plurality of electronic elements. At this time, the computer system 200 enters the simulated mechanical off state G3″ from the power state S4/S5. When the computer system 200 receives a wake-up event under the simulated mechanical off state G3″, the switch control circuit 220 restores the output of the stand-by power V_{SB} to the memory device 230, the wake-up device 240, and the other electronic elements 250 among the plurality of electronic elements 230˜250, and controls the computer system 200 to return to the power state S4/S5 from the simulated mechanical off state G3″ and then return to the normal state S0 from the power state S4/S5. In this fourth case, all of the stand-by power V_{SB} can be powered off under the simulated mechanical off state G3″, except the battery power V_{BAT} is provided. By this time, the simulated mechanical off state G3″ herein can be viewed to be completely identical to the mechanical off state G3. What calls for special attention is that in this fourth case, the wake-up device 240 inside the computer system 200 is not supplied with power under the simulated mechanical off state G3″. For this reason, the wake-up event needs to be triggered by means of external wake-up devices only, such as a power button.

The abovementioned embodiments are presented merely for describing the present invention, and in no way should be considered to be limitations of the scope of the present invention. Those skilled in the art should appreciate that the switch control circuit 220 can decide the type and the number of the electronic elements have no need to be supplied with the stand-by power V_{SB} depends upon different design demands and different conditions. In addition, the computer system 200 can be a desktop computer, but the present invention is not limited to this only.

Please refer to FIG. 5. FIG. 5 is a diagram of a computer system 500 for saving power consumption of a stand-by/power off state according to a second embodiment of the present invention. As shown in FIG. 5, the computer system 500 includes, but is not limited to, a power supply circuit 510, a power converting circuit 570, a switch control circuit 520, and a plurality of electronic elements 530˜550. In this embodiment, a memory device 530, a wake-up device 540 (for example, a device equipped with a wake-up function, such as a network card, a keyboard, or an infrared remote controller), and other electronic elements 550 are taken as an example for illustration, but the present invention is not limited to this only. The power supply circuit 510 provides a second input power P_{DC} according to a first input power P_{AC}, wherein the first input power P_{AC} can be an alternating current (AC) of 110V/220V provided from a socket, and the second input power P_{DC} can consist of a direct current (DC) of 19V′˜24V. In addition, the power converting circuit 570, the switch control circuit 520, the memory device 530, the wake-up device 540, and the other electronic elements 550 are all disposed on a motherboard 560. The power converting circuit 570 is coupled between the power supply circuit 510 and the memory device 530, the wake-up device 540, as well as the other electronic elements 550. The power converting circuit 570 is used for converting the second input power P_{DC} into at least one main power V_{CC} and a stand-by power V_{SB}. In this embodiment, the stand-by power V_{SB} consists of a plurality of stand-by voltage levels V_{SB1}, V_{SB2}, and V_{SB3} respectively provided for the memory device 530, the wake-up device 540, as well as the other electronic elements 550, but this should not be considered as limitations of the present invention.

Please keep referring to FIG. 5. The switch control circuit 520 is coupled to the power converting circuit 570. When the computer system 500 receives a stand-by/power off command under a normal state (e.g. the power state S0), the switch control circuit 520 controls the computer system 500 to enter a stand-by/power off state (e.g. the power state S3, S4, or S5) from the normal state S0 and controls the power converting circuit 570 to stop converting the second input power P_{DC} into at least one part of stand-by voltage levels among the plurality of stand-by voltage levels (including V_{SB1}, V_{SB2}, and V_{SB3}), such that the computer system 500 has entered a simulated mechanical off state (represented by G3′ or G3″) from the stand-by/power off state at this time. When the computer system 500 receives a wake-up event under the simulated mechanical off state, the switch control circuit 520 controls the power converting circuit 570 to continue converting the second input power P_{DC} into the plurality of stand-by voltage levels (including V_{SB1}, V_{SB2}, and V_{SB3}), and controls the computer system 500 to return to the stand-by/power off state from the simulated mechanical off state and then return to the normal state from the stand-by/power off state. That is to say, G3′→S3→S0 or G3″→S4/S5→S0.

Please note that a number of the converted stand-by voltage levels when the computer system 500 lies under the simulated mechanical off state (e.g., the power state G3′/G3″) is smaller than a number of the converted stand-by voltage levels when the computer system 500 lies under the stand-by/power off state (e.g., the power state S3, S4, or S5). For example, when the computer system 500 lies under the power state S3, the converted stand-by voltage levels include V_{SB1} (provided for the memory device 530), V_{SB2} (provided for the wake-up device 540), and V_{SB3} (provided for the other electronic elements 550). And thus a total number of the converted stand-by voltage levels is equal to 3 under the power state S3. On the other hand, when the computer system 500 lies under the simulated mechanical off state G3′/G3″, the total number of the converted stand-by voltage levels is equal to 2, wherein only V_{SB1} and V_{SB2} are included. For this reason, if the computer system 500 is controlled to enter the stand-by/power off state from the normal state and then enter the simulated mechanical off state from the stand-by/power off state, the power consumption of the computer system 500 under the stand-by/power off state can be substantially reduced.

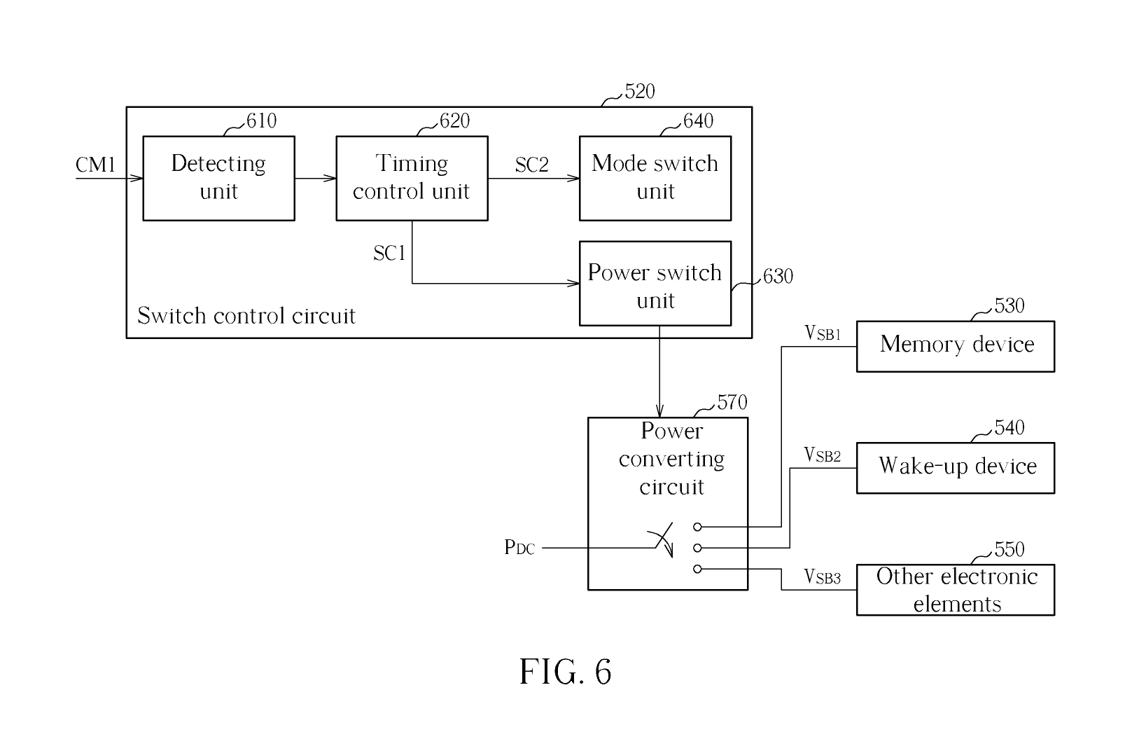

Please refer to FIG. 6. FIG. 6 is a diagram showing an exemplary embodiment of the switch control circuit 520 shown in FIG. 5. In this embodiment, the switch control circuit 520 is applied to a condition that the computer system 500 lies under the normal state S0. As shown in FIG. 6, the switch control circuit 520 includes, but is not limited to, a detecting unit 610, a timing control unit 620, a power switch unit 630, and a mode switch unit 640. The architecture of the switch control circuit 520 shown in FIG. 6 is similar to that of the switch control circuit 220 shown in FIG. 3, and the difference between them is that the power switch unit 630 of the switch control circuit 520 shown in FIG. 6 will control the power converting circuit 570 to stop converting the second input power P_{DC} into at least one part of stand-by voltage levels among the plurality of stand-by voltage levels (including V_{SB1}, V_{SB2}, and V_{SB3}) when the power switch control signal SC1 is received.

To make it simply, if the switch control circuit 520 receives the stand-by/power off command CM1 during the computer system 500 lies under the normal state S0, it will firstly transmit the mode switch control signal SC2 for controlling the computer system 500 to enter the stand-by/power off state from the normal state S0 and then transmit the power switch control signal SC1 to control the power converting circuit 570 to stop converting the second input power P_{DC} into at least one part of stand-by voltage levels among the plurality of stand-by voltage levels V_{SB1} ˜V_{SB3}. At this time, the computer system 500 has entered the simulated mechanical off state from the stand-by/power off state. That is, S0→S3→G3′ or S0→S4/S5→G3″. Therefore, the power consumption of the computer system 500 under the stand-by/power off state can be saved.

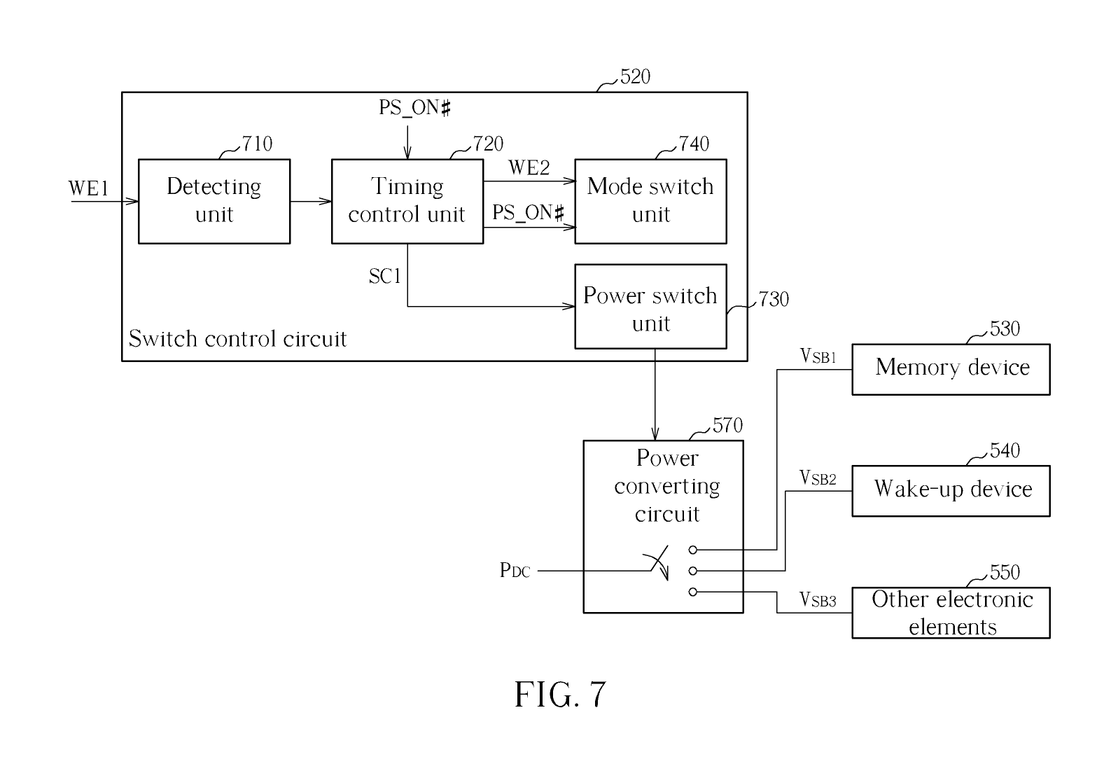

Please refer to FIG. 7. FIG. 7 is a diagram showing another exemplary embodiment of the switch control circuit 520 shown in FIG. 5. In this embodiment, the switch control circuit 520 is applied to a condition that the computer system 500 enters to the simulated mechanical off state G3′/G3″. As shown in FIG. 7, the switch control circuit 520 includes, but is not limited to, a detecting unit 710, a timing control unit 720, a power switch unit 730, and a mode switch unit 740. The architecture of the switch control circuit 520 shown in FIG. 7 is similar to that of the switch control circuit 220 shown in FIG. 4, and the difference between them is that the power switch unit 730 of the switch control circuit 520 shown in FIG. 7 will control the power converting circuit 570 to continue converting the second input power P_{DC} into the plurality of stand-by voltage levels (including V_{SB1}, V_{SB2}, and V_{SB3}) when the power switch control signal SC1 is received.

To make it simply, if the switch control circuit 520 receives the wake-up event WE1 during the computer system 500 enters to the simulated mechanical off state G3′/G3″, it will hold the power supply start signal PS_ON# temporarily and generate the power switch control signal SC1 to control the power converting circuit 570 to continue converting the second input power P_{pc} into the plurality of stand-by voltage levels. After that, the control circuit 520 outputs the power supply start signal PS_ON# as well as the output wake-up event WE2 to control the computer system 500 to return to the stand-by/power off state from the simulated mechanical off state and then return to the normal state from the stand-by/power off state. That is, G3′→S3→S0 or G3″→S4/S5→S0. Therefore, even if the computer system 500 enters to the simulated mechanical off state G3′/G3″, it can still wake up to work if needed (for example, when a network wake-up event is received).

Please note that the computer system 500 can be a laptop computer or a notebook computer, but the present invention is not limited to this only.

The abovementioned embodiments are presented merely for describing the present invention, and in no way should be considered to be limitations of the scope of the present invention. Those skilled in the art should appreciate that other circuit architectures can be adopted to implement the switch control circuits 220 and 520 without departing from the spirit of the present invention, which also belongs to the scope of the present invention.

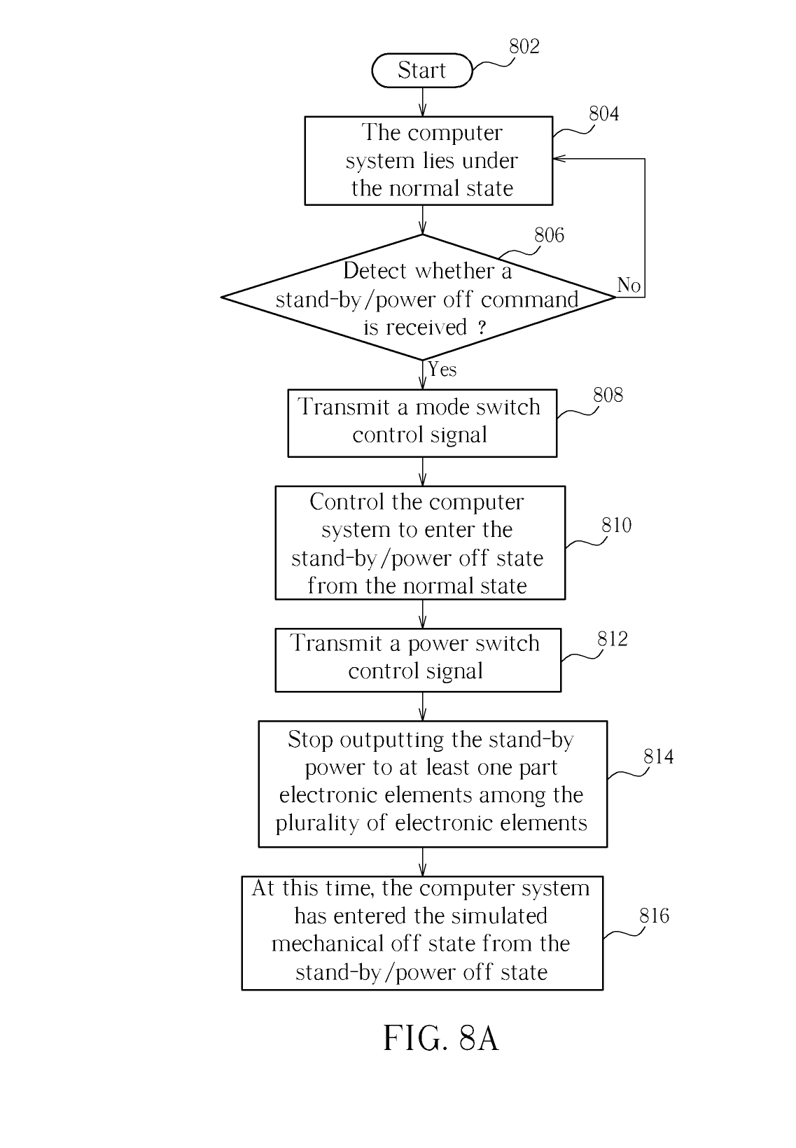

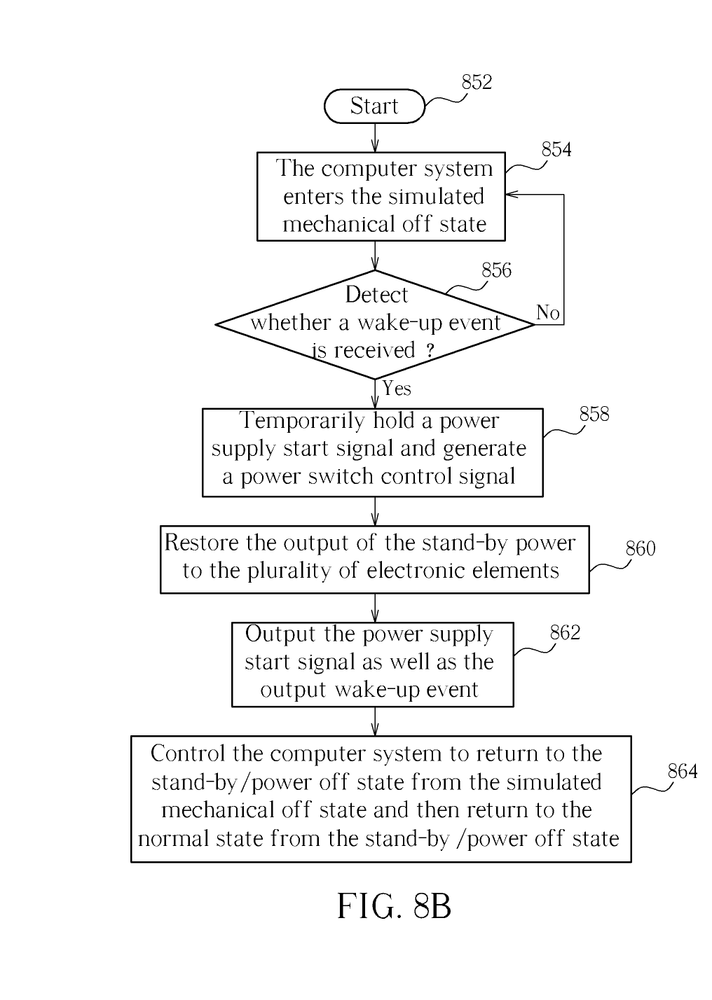

Please refer to FIG. 8A. FIG. 8A is a flowchart illustrating a method for saving power consumption of a computer system under a stand-by/power off state according to an exemplary embodiment of the present invention. Please note that the following steps are not limited to be performed according to the exact sequence shown in FIG. 8A if a roughly identical result can be obtained. The method includes, but is not limited to, the following steps:

Step 802: Start.

Step 804: The computer system lies under the normal state.

Step 806: When the computer system lies under the normal state, detect whether a stand-by/power off command is received. When the stand-by/power off command is detected to be received, go to Step 808; otherwise, go to Step 804.

Step 808: When the stand-by/power off command is detected to be received, transmit a mode switch control signal.

Step 810: When the mode switch control signal is received, control the computer system to enter the stand-by/power off state from the normal state.

Step 812: Transmit a power switch control signal.

Step 814: When the power switch control signal is received, stop outputting the stand-by power to at least one part electronic elements among the plurality of electronic elements.

Step 816: At this time, the computer system has entered the simulated mechanical off state from the stand-by/power off state.

How each element operates can be known by collocating the steps shown in FIG. 8A and the elements shown in FIG. 2 and FIG. 3, and further description is omitted here for brevity. Be noted that the step 806 is executed by the detecting unit 310, the steps 808 and 812 are executed by the timing control unit 320, the step 810 is executed by the mode switch unit 340, and the step 814 is executed by the power switch unit 330.

Please refer to FIG. 8B. FIG. 8B is a flowchart illustrating a method for saving power consumption of a computer system under a stand-by/power off state according to another exemplary embodiment of the present invention. As FIG. 8B depicts, the method includes, but is not limited to, the following steps:

Step 852: Start.

Step 854: The computer system enters the simulated mechanical off state.

Step 856: When the computer system enters the simulated mechanical off state, detect whether a wake-up event is received. When the wake-up event is detected to be received, go to Step 858; otherwise, go to Step 854.

Step 858: When the wake-up event is detected to be received, temporarily hold a power supply start signal and generate a power switch control signal.

Step 860: When the power switch control signal is received, restore the output of the stand-by power to the plurality of electronic elements.

Step 862: After restoring the output of the stand-by power to the plurality of electronic elements, output the power supply start signal as well as the output wake-up event.

Step 864: When the power supply start signal as well as the output wake-up event are received, control the computer system to return to the stand-by/power off state from the simulated mechanical off state and then return to the normal state from the stand-by/power off state.

How each element operates can be known by collocating the steps shown in FIG. 8B and the elements shown in FIG. 2 and FIG. 4, and further description is omitted here for brevity. Be noted that the step 856 is executed by the detecting unit 410, the steps 858 and 862 are executed by the timing control unit 420, the step 860 is executed by the power switch unit 430, and the step 864 is executed by the mode switch unit 440. What calls for special attention is that the flowchart in FIG. 8A represents the steps aimed at how the computer system 200 enters the simulated mechanical off state G3′/G3″ from the normal state S0, and the flowchart in FIG. 8B represents the steps aimed at how the computer system 200 returns to the normal state S0 from the simulated mechanical off state G3′/G3″.

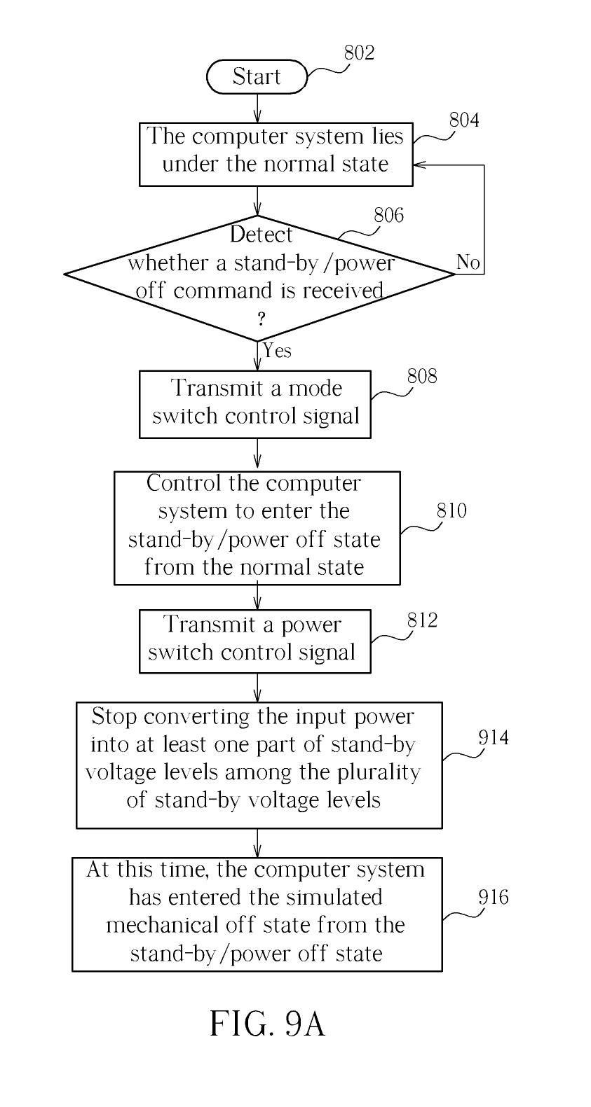

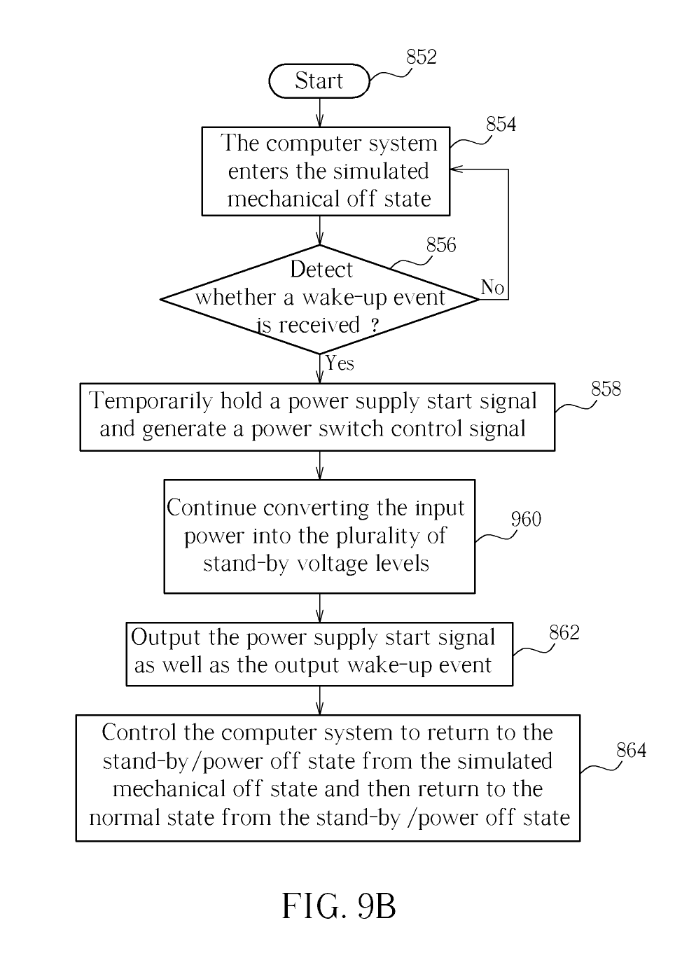

Please refer to FIG. 9A. FIG. 9A is a flowchart illustrating a method for saving power consumption of a computer system under a stand-by/power off state according to another exemplary embodiment of the present invention. The method includes, but is not limited to, the following steps:

Step 802: Start.

Step 804: The computer system lies under the normal state.

Step 806: When the computer system lies under the normal state, detect whether a stand-by/power off command is received. When the stand-by/power off command is detected to be received, go to Step 808; otherwise, go to Step 804.

Step 808: When the stand-by/power off command is detected to be received, transmit a mode switch control signal.

Step 810: When the mode switch control signal is received, control the computer system to enter the stand-by/power off state from the normal state.

Step 812: Transmit a power switch control signal.

Step 914: When the power switch control signal is received, stop converting the input power into at least one part of stand-by voltage levels among the plurality of stand-by voltage levels.

Step 816: At this time, the computer system has entered the simulated mechanical off state from the stand-by/power off state.

Please note that the steps shown in FIG. 9A are similar to the steps shown in FIG. 8A, and the difference between them is that the step 914 shown in FIG. 9A is used for replacing the step 814 shown in FIG. 8A. How each element operates can be known by collocating the steps shown in FIG. 9A and the elements shown in FIG. 5 and FIG. 6, and further description is omitted here for brevity. Be noted that the step 806 is executed by the detecting unit 610, the steps 808 and 812 are executed by the timing control unit 620, the step 810 is executed by the mode switch unit 640, and the step 914 is executed by the power switch unit 630.

Please refer to FIG. 9B. FIG. 9B is a flowchart illustrating a method for saving power consumption of a computer system under a stand-by/power off state according to another exemplary embodiment of the present invention. The method includes, but is not limited to, the following steps:

Step 852: Start.

Step 854: The computer system enters the simulated mechanical off state.

Step 856: When the computer system enters the simulated mechanical off state, detect whether a wake-up event is received. When the wake-up event is detected to be received, go to Step 858; otherwise, go to Step 854.

Step 858: When the wake-up event is detected to be received, temporarily hold a power supply start signal and generate a power switch control signal.

Step 960: When the power switch control signal is received, continue converting the input power into the plurality of stand-by voltage levels.

Step 862: After restoring the output of the stand-by power to the plurality of electronic elements, output the power supply start signal as well as the output wake-up event.

Step 864: When the power supply start signal as well as the output wake-up event are received, control the computer system to return to the stand-by/power off state from the simulated mechanical off state and then return to the normal state from the stand-by/power off state.

Please note that the steps shown in FIG. 9B are similar to the steps shown in FIG. 8B, and the difference between them is that the step 960 shown in FIG. 9B is used for replacing the step 860 shown in FIG. 8B. How each element operates can be known by collocating the steps shown in FIG. 9B and the elements shown in FIG. 5 and FIG. 7, and further description is omitted here for brevity. Be noted that the step 856 is executed by the detecting unit 710, the steps 858 and 862 are executed by the timing control unit 720, the step 960 is executed by the power switch unit 730, and the step 864 is executed by the mode switch unit 740. What calls for special attention is that the flowchart in FIG. 9A represents the steps aimed at how the computer system 500 enters the simulated mechanical off state G3′/G3″ from the normal state S0, and the flowchart in FIG. 9B represents the steps aimed at how the computer system 500 returns to the normal state S0 from the simulated mechanical off state G3′/G3″.

Please note that, the steps of the abovementioned flowcharts are merely practicable embodiments of the present invention, and in no way should be considered to be limitations of the scope of the present invention. Those skilled in the art should appreciate that the methods shown in FIG. 8A, FIG. 8B, FIG. 9A, and FIG. 9B can include other intermediate steps or several steps can be merged into a single step without departing from the spirit of the present invention.

The abovementioned embodiments are presented merely for describing features of the present invention, and in no way should be considered to be limitations of the scope of the present invention. In summary, the present invention provides a computer system for saving power consumption of a stand-by/power state (e.g. the power state S3, S4, or S5) and a related method. When the computer system enters the stand-by/power state, the stand-by power V_{SB} provided for one part (or all) of the electronic elements can be stopped and the computer system can enter the simulated mechanical off state G3′/G3″. On the other hand, if the computer system needs to wake up to work (for example, when a wake-up event is received), the computer system can return to the stand-by/power off state form the simulated mechanical off state and then return to the normal state from the stand-by/power off state timely. Therefore, an optimum power-saving performance can be achieved. In addition, the switch control circuit 220/520 disclosed in the present invention can be implemented easily and is not power-consuming, which has a good control upon cost and power consumption. Moreover, the power-saving mechanism disclosed in the present invention has a wide range of applications, which is suitable for a desktop computer, a laptop computer, a notebook computer, or a computer system of other types.

Those skilled in the art will readily observe that numerous modifications and alterations of the device and method may be made while retaining the teachings of the invention.

What is claimed is:

1. A computer system for saving power consumption of a stand-by/power off state, comprising:
a plurality of electronic elements; and
a switch control circuit, coupled to the plurality of electronic elements, the switch control circuit used for controlling the computer system to enter the stand-by/power off state from a normal state when the computer system receives a stand-by/power off command under the normal state, and for stopping outputting a stand-by power having at least one stand-by voltage level to at least one part of electronic elements among the plurality of electronic elements, such that the computer system has entered a simulated mechanical off state from the stand-by/power off state at this time;
wherein a number of electronic elements supplied by the stand-by power when the computer system lies under the simulated mechanical off state is smaller than a number of electronic elements supplied by the stand-by power when the computer system lies under the stand-by/power off state.

2. The computer system of claim 1, wherein the switch control circuit is further used for:
restoring the output of the stand-by power to the plurality of electronic elements when the computer system receives a wake-up event under the simulated mechanical off state, and controlling the computer system to return to the stand-by/power off state from the simulated mechanical off state and then return to the normal state from the stand-by/power off state.

3. The computer system of claim 2, wherein the stand-by/power off state is a stand-by state (S3), the plurality of electronic elements comprises a memory device, a wake-up device and other electronic elements, and the switch control circuit is used for:
controlling the computer system to enter the stand-by state from the normal state and stopping outputting the stand-by power to the wake-up device and the other electronic elements among the plurality of electronic elements, such that the computer system has entered to the simulated mechanical off state from the stand-by state at this time; and
restoring the output of the stand-by power to the wake-up device and the other electronic elements among the plurality of electronic elements, and controlling the computer system to return to the stand-by state from the simulated mechanical off state and then return to the normal state from the stand-by state.

4. The computer system of claim 2, wherein the stand-by/power off state is one of a sleeping state (S4) and a power off state (S5), the plurality of electronic elements comprises a memory device, a wake-up device and other electronic elements, and the switch control circuit is used for:
controlling the computer system to enter the stand-by/power off state from the normal state, and stopping outputting the stand-by power to the memory device, the wake-up device and the other electronic elements among the plurality of electronic elements, such that the computer system has entered the simulated mechanical off state from the stand-by/power off state at this time; and
restoring the output of the stand-by power to the memory device, the wake-up device and the other electronic elements among the plurality of electronic elements, and controlling the computer system to return to the stand-by/power off state from the simulated mechanical off state and then return to the normal state from the stand-by/power off state.

5. The computer system of claim 2, wherein the stand-by/power off state is a stand-by state (S3), the plurality of electronic elements comprises a memory device, a wake-up device and other electronic elements, and the switch control circuit is used for:
controlling the computer system to enter the stand-by state from the normal state, and stopping outputting the stand-by power to the other electronic elements among the plurality of electronic elements, such that the computer system has entered the simulated mechanical off state from the stand-by state at this time; and
restoring the output of the stand-by power to the other electronic elements among the plurality of electronic elements, and controlling the computer system to return to the stand-by state from the simulated mechanical off state and then return to the normal state from the stand-by state.

6. The computer system of claim 2, wherein the stand-by/power off state is one of a sleeping state (S4) and a power off state (S5), the plurality of electronic elements comprises a memory device, a wake-up device and other electronic elements, and the switch control circuit is used for:
controlling the computer system to enter the stand-by/power off state from the normal state, and stopping outputting the stand-by power to the memory device and the other electronic elements among the plurality of electronic elements, such that the computer system has entered the simulated mechanical off state from the stand-by/power off state at this time; and
restoring the output of the stand-by power to the memory device and the other electronic elements among the plurality of electronic elements, and controlling the computer system to return to the stand-by/power off state from the simulated mechanical off state and then return to the normal state from the stand-by/power off state.

7. The computer system of claim 2, wherein the switch control circuit comprises:
a detecting unit, for detecting whether the wake-up event is received when the computer system enters to the simulated mechanical off state;
a timing control unit, coupled to the detecting unit, for holding a power supply start signal and for generating a power switch control signal when the detecting unit detects that the wake-up event is received;
a power switch unit, coupled to the timing control unit, for restoring the output of the stand-by power to the plurality of electronic elements when the power switch control signal is received, wherein the timing control unit outputs the power supply start signal and an output wake-up event corresponding to the wake-up event after the power switch unit restores the output of the stand-by power to the plurality of electronic elements; and
a mode switch unit, coupled to the timing control unit, for controlling the computer system to return to the stand-by/power off state from the simulated mechanical off state and then return to the normal state from the stand-by/power off state when the power supply start signal and the output wake-up event are received.

8. The computer system of claim 2, wherein the switch control circuit comprises:
a detecting unit, for detecting whether the stand-by/power off command is received when the computer system lies under the normal state;
a timing control unit, coupled to the detecting unit, for generating a mode switch control signal when the detecting unit detects that the stand-by/power off command is received;
a mode switch unit, coupled tot eh timing control unit, for controlling the computer system to enter to the stand-by/power off state from the normal state when the mode switch control signal is received, wherein the timing control unit transmits a power switch control signal after the computer system enters to the stand-by/power off state; and
a power switch unit, coupled to the timing control unit, for stopping outputting the stand-by power to at least one part of electronic elements among the plurality of electronic elements when the power switch control signal is received, wherein the computer system enters to the simulated mechanical off state from the stand-by/power off state after the power switch unit stops outputting the stand-by power to at least one part of electronic elements among the plurality of electronic elements.

9. A computer system for saving power consumption of a stand-by/power off state, comprising:
a power converting circuit, for converting an input power into a main power as well as a stand-by power comprising a plurality of stand-by voltage levels;
a plurality of electronic elements, coupled to the power converting circuit, wherein power supplies of the plurality of electronic elements are derived from the main power as well as the stand-by power; and
a switch control circuit, coupled to the power converting circuit, the switch control circuit used for controlling the computer system to enter the stand-by/power off state from a normal state when the computer system receives a stand-by/power off command under the normal state, and for controlling the power converting circuit to stop converting the input power into at least one part of stand-by voltage levels among the plurality of stand-by voltage levels, such that the computer system has entered a simulated mechanical off state from the stand-by/power off state at this time.

10. The computer system of claim 9, wherein the switch control circuit is further used for:
when the computer system receives a wake-up event under the simulated mechanical off state, controlling the power converting circuit to continue converting the input power into the plurality of stand-by voltage levels and controlling the computer system to return to the stand-by/power off state from the simulated mechanical off state and then return to the normal state from the stand-by/power off state.

11. The computer system of claim 10, wherein the stand-by/power off state is a stand-by state (S3), the plurality of electronic elements comprises a memory device, a wake-up device and other electronic elements, and the switch control circuit is used for:
controlling the computer system to enter the stand-by state from the normal state, and controlling the power converting circuit to stop converting the input power into the stand-by voltage levels supplied to the wake-up device and the other electronic elements among the plurality of electronic elements, such that the computer system has entered to the simulated mechanical off state from the stand-by state at this time; and
controlling the power converting circuit to continue converting the input power into the stand-by voltage levels supplied to the wake-up device and the other electronic elements among the plurality of electronic elements, and controlling the computer system to return to the stand-by state from the simulated mechanical off state and then return to the normal state from the stand-by state.

12. The computer system of claim 10, wherein the stand-by/power off state is one of a sleeping state (S4) and a power off state (S5), the plurality of electronic elements comprises a memory device, a wake-up device and other electronic elements, and the switch control circuit is used for:
controlling the computer system to enter the stand-by/power off state from the normal state, and controlling the power converting circuit to stop converting the input power into the stand-by voltage levels supplied to the memory device, the wake-up device and the other electronic elements among the plurality of electronic elements, such that the computer system has entered to the simulated mechanical off state from the stand-by state at this time; and
controlling the power converting circuit to continue converting the input power into the stand-by voltage levels supplied to the memory device, the wake-up device and the other electronic elements among the plurality of electronic elements, and controlling the computer system to return to the stand-by state from the simulated mechanical off state and then return to the normal state from the stand-by state.

13. The computer system of claim 10, wherein the stand-by/power off state is a stand-by state (S3), the plurality of electronic elements comprises a memory device, a wake-up device and other electronic elements, and the switch control circuit is used for:
controlling the computer system to enter the stand-by state from the normal state, and controlling the power converting circuit to stop converting the input power into the stand-by voltage levels supplied to the other electronic elements among the plurality of electronic elements, such that the computer system has entered to the simulated mechanical off state from the stand-by state at this time; and
controlling the power converting circuit to continue converting the input power into the stand-by voltage levels supplied to the other electronic elements among the plurality of electronic elements, and controlling the computer system to return to the stand-by state from the simulated mechanical off state and then return to the normal state from the stand-by state.

14. The computer system of claim 10, wherein the stand-by/power off state is one of a sleeping state (S4) and a power off state (S5), the plurality of electronic elements comprises a memory device, a wake-up device and other electronic elements, and the switch control circuit is used for:
controlling the computer system to enter the stand-by/power off state from the normal state, and controlling the power converting circuit to stop converting the input power into the stand-by voltage levels supplied to the memory device and the other electronic elements among the plurality of electronic elements, such that the computer system has entered to the simulated mechanical off state from the stand-by state at this time; and
controlling the power converting circuit to continue converting the input power into the stand-by voltage levels supplied to the memory device and the other electronic elements among the plurality of electronic elements, and controlling the computer system to return to the stand-by state from the simulated mechanical off state and then return to the normal state from the stand-by state.

15. The computer system of claim 10, wherein the switch control circuit comprises:
a detecting unit, for detecting whether the wake-up event is received when the computer system enters to the simulated mechanical off state;
a timing control unit, coupled to the detecting unit, for holding a power supply start signal and for generating a power switch control signal when the detecting unit detects that the wake-up event is received;
a power switch unit, coupled to the timing control unit, for controlling the power converting circuit to continue converting the input power into the plurality of stand-by voltage levels elements when the power switch control signal is received, wherein the timing control unit outputs the power supply start signal and an output wake-up event corresponding to the wake-up event after the power switch unit continues converting the input power into the plurality of stand-by voltage levels; and
a mode switch unit, coupled to the timing control unit, for controlling the computer system to return to the stand-by/power off state from the simulated mechanical off state and then return to the normal state from the stand-by/power off state when the power supply start signal and the output wake-up event are received.

16. The computer system of claim 10, wherein the switch control circuit comprises:
a detecting unit, for detecting whether the stand-by/power off command is received when the computer system lies under the normal state;
a timing control unit, coupled to the detecting unit, for generating a mode switch control signal when the detecting unit detects that the stand-by/power off command is received;
a mode switch unit, coupled tot eh timing control unit, for controlling the computer system to enter to the stand-by/power off state from the normal state when the mode switch control signal is received, wherein the timing control unit transmits a power switch control signal after the computer system enters to the stand-by/power off state; and
a power switch unit, coupled to the timing control unit, for controlling the power converting circuit to stop converting the input power into at least one part of stand-by voltage levels among the plurality of stand-by voltage levels when the power switch control signal is received, wherein the computer system enters to the simulated mechanical off state from the stand-by/power off state after the power converting circuit stops converting the input power into at least one part of stand-by voltage levels among the plurality of stand-by voltage levels.

17. A method for saving power consumption of a computer system under a stand-by/power off state, the computer system comprising a plurality of electronic elements, the method comprising the steps of:
when the computer system receives a stand-by/power off command under a normal state, controlling the computer system to enter the stand-by/power off state from the normal state; and
stopping outputting a stand-by power having at least one stand-by voltage level to at least one part of electronic elements among the plurality of electronic elements, such that the computer system has entered a simulated mechanical off state from the stand-by/power off state at this time;
wherein a number of electronic elements supplied by the stand-by power when the computer system lies under the simulated mechanical off state is smaller than a number of electronic elements supplied by the stand-by power when the computer system lies under the stand-by/power off state.

18. The method of claim 17, further comprising:
when the computer system receives a wake-up event under the simulated mechanical off state, restoring the output of the stand-by power to the plurality of electronic elements; and
controlling the computer system to return to the stand-by/power off state from the simulated mechanical off state and then return to the normal state from the stand-by/power off state.

19. The method of claim 18, wherein when the computer system receives a wake-up event under the simulated mechanical off state, the step of restoring the output of the stand-by power to the plurality of electronic elements and the step of controlling the computer system to return to the stand-by/power off state from the simulated mechanical off state and then return to the normal state from the stand-by/power off state comprise:
when the computer system enters to the simulated mechanical off state, detecting whether the wake-up event is received;
when the wake-up event is detected to be received, holding a power supply start signal and generating a power switch control signal;
when the power switch control signal is received, restoring the output of the stand-by power to the plurality of electronic elements;
after the power switch unit restores the output of the stand-by power to the plurality of electronic elements, outputting the power supply start signal and an output wake-up event corresponding to the wake-up event; and
when the power supply start signal and the output wake-up event are received, controlling the computer system to return to the stand-by/power off state from the simulated mechanical off state and then return to the normal state from the stand-by/power off state.

20. The method of claim 18, wherein when the computer system receives the stand-by/power off command under the normal state, the step of controlling the computer system to enter the stand-by/power off state from the normal state and the step of stopping outputting the stand-by power having at least one stand-by voltage level to at least one part of electronic elements among the plurality of electronic elements comprise:
when the computer system lies under the normal state, detecting whether the stand-by/power off command is received;
when the detecting unit detects that the stand-by/power off command is received, generating a mode switch control signal;
when the mode switch control signal is received, controlling the computer system to enter to the stand-by/power off state from the normal state;
after the computer system enters to the stand-by/power off state, transmitting a power switch control signal; and
when the power switch control signal is received, stopping outputting the stand-by power to at least one part of electronic elements among the plurality of electronic elements, such that the computer system enters to the simulated mechanical off state from the stand-by/power off state.

21. The method of claim 17, wherein the stand-by/power off state comprises one of a stand-by state (S3), a sleeping state (S4) and a power off state (S5).

22. A method for saving power consumption of a computer system under a stand-by/power off state, the computer system comprising a plurality of electronic elements, and power supplies of the plurality of electronic elements derived from a main power as well as a stand-by power comprising a plurality of stand-by voltage levels, the method comprising the steps of:
when the computer system receives a stand-by/power off command under the normal state, controlling the computer system to enter the stand-by/power off state from a normal state; and
stopping converting an input power into at least one part of stand-by voltage levels among the plurality of stand-by voltage levels, such that the computer system has entered a simulated mechanical off state from the stand-by/power off state at this time.

23. The method of claim 22, further comprising:
when the computer system receives a wake-up event under the simulated mechanical off state, continuing converting the input power into the plurality of stand-by voltage levels; and
controlling the computer system to return to the stand-by/power off state from the simulated mechanical off state and then return to the normal state from the stand-by/power off state.

24. The method of claim. 23, wherein when the computer system receives the wake-up event under the simulated mechanical off state, the step of continuing converting the input power into the plurality of stand-by voltage levels and the step of controlling the computer system to return to the stand-by/power off state from the simulated mechanical off state and then return to the normal state from the stand-by/power off state comprise:
when the computer system enters to the simulated mechanical off state, detecting whether the wake-up event is received;
when the wake-up event is detected to be received, holding a power supply start signal and generating a power switch control signal;
when the power switch control signal is received, continuing converting the input power into the plurality of stand-by voltage levels elements;
after continuing converting the input power into the plurality of stand-by voltage levels, outputting the power supply start signal and an output wake-up event corresponding to the wake-up event; and
when the power supply start signal and the output wake-up event are received, controlling the computer system to return to the stand-by/power off state from the simulated mechanical off state and then return to the normal state from the stand-by/power off state.

25. The method of claim. 23, wherein when the computer system receives the stand-by/power off command under the normal state, the step of controlling the computer system to enter the stand-by/power off state from the normal state and the step of stopping converting an input power into at least one part of stand-by voltage levels among the plurality of stand-by voltage levels comprise:
when the computer system lies under the normal state, detecting whether the stand-by/power off command is received;
when the stand-by/power off command is detected to be received, generating a mode switch control signal;
when the mode switch control signal is received, controlling the computer system to enter to the stand-by/power off state from the normal state;
after the computer system enters to the stand-by/power off state, transmitting a power switch control signal; and
when the power switch control signal is received, controlling the power converting circuit to stop converting the input power into at least one part of stand-by voltage levels among the plurality of stand-by voltage levels, such that the computer system enters to the simulated mechanical off state from the stand-by/power off state.

26. The method of claim 12, wherein the stand-by/power off state comprises one of a stand-by state (S3), a sleeping state (S4) and a power off state (S5).
